(19) United States
(12) Patent Application Publication
(10) Pub. No.: US 2026/0090868 A1
(43) Pub. Date: Apr. 2, 2026

(54) BASE STATION UNIT, ORAL CARE DEVICE, AND VIBRATION DAMPING STRUCTURE

(71) Applicant: Shenzhen Soocas Technology Co., Ltd., Shenzhen (CN)

(72) Inventors: Qingshan YIN, Shenzhen (CN); Yuanping ZHANG, Shenzhen (CN); Xiongnan JIANG, Shenzhen (CN)

(73) Assignee: Shenzhen Soocas Technology Co., Ltd., Shenzhen (CN)

(21) Appl. No.: 18/991,904

(22) Filed: Dec. 23, 2024

Related U.S. Application Data
(63) Continuation of application No. PCT/CN2024/127167, filed on Oct. 24, 2024.

(30) Foreign Application Priority Data
Sep. 30, 2024 (CN) 202411398781.4

(51) Int. Cl. A61C 17/024; A61C 17/02

(52) U.S. Cl. CPC A61C 17/024; A61C 17/0202

(57) ABSTRACT

The present disclosure discloses a base station unit, an oral care device, and a vibration damping structure. The base station unit includes a main shell body, a first load-bearing member, and a first power assembly, where the main shell body has an accommodating chamber. The first load-bearing member positioned within the accommodating chamber is connected to the main shell body and divides the accommodating chamber into a first cavity positioned above and a second cavity positioned below. The first power assembly is connected to the first load-bearing member and suspended in the second cavity.

### CROSS REFERENCE TO RELATED APPLICATION

This application is a continuation of International Application No. PCT/CN2024/127167, filed on Oct. 24, 2024, which claims priority to Chinese Patent Application No. 202411398781.4, titled “BASE STATION UNIT, ORAL CARE DEVICE, AND VIBRATION DAMPING STRUCTURE” and filed to the China National Intellectual Property Administration on Sep. 30, 2024, the entire contents of which are incorporated herein by reference.

### TECHNICAL FIELD

The present disclosure relates to the technical field of oral care technology, and more particularly, to a base station unit, an oral care device, and a vibration damping structure.

### BACKGROUND

In related technologies, oral irrigators drive water pumps by means of motors, to generate high-speed water flow or pulsed water flow that can penetrate into regions difficult to clean, such as teeth and gums, to effectively remove food residue and bacteria.

However, generally the motors and the water pumps are directly connected to outer shell bodies of base station units. During use, operation of the motors and the water pumps may cause the outer shell bodies to produce noises, which adversely affects user experience.

### SUMMARY

An objective of the present disclosure is to provide a base station unit, an oral care device and a vibration damping structure, which can reduce vibration and noise of the base station unit and improve user experience.

To achieve the above objective, one aspect of the present disclosure provides a base station unit, which includes:
a main shell body having an accommodating chamber;
a first load-bearing member positioned within the accommodating chamber, where the first load-bearing member is connected to the main shell body and divides the accommodating chamber into a first cavity positioned above and a second cavity positioned below; and
a first power assembly connected to the first load-bearing member and suspended in the second cavity.

In the technical solutions provided by the present disclosure, the first power assembly is connected to the first load-bearing member and is suspended in the second cavity. That is, there is a predetermined height between the first power assembly and a bottom of the main shell body, and the first power assembly is suspended with respect to the bottom of the main shell body. In this way, an air or space gap may be formed between the first power assembly and the bottom of the main shell body, where this gap may serve as a vibration isolation layer to prevent vibration of the first power assembly from directly transmitting to the bottom of the main shell body in contact with a placement tabletop of the base station unit, thereby reducing the vibration transmitted to the main shell body. Meanwhile, when the first power assembly is in operation, the vibration generated by the first power assembly first acts on the first load-bearing member, rather than being directly transmitted to the main shell body. In this way, the first load-bearing member undergoes deformation and absorbs vibration energy when it is subjected to vibration, thereby reducing the vibration transmitted from the first power assembly to the main shell body by means of the first load-bearing member. In this way, as the vibration of the main shell body decreases, the noise generated by the vibration of the main shell body may be reduced, thereby improving the user experience.

To achieve the above objective, another aspect of the present disclosure also provides a base station unit, which includes:
a main shell body having an accommodating chamber;
a first load-bearing member positioned within the accommodating chamber,
the first load-bearing member including a strut member, a first connector and a first connecting arm, where the strut member is connected to the main shell body, a middle of the strut member is provided with a first notch running through the strut member, and the first connector is positioned within the first notch and is connected to the strut member by means of the first connecting arm; and
a first power assembly connected to the first connector and suspended in the accommodating chamber.

To achieve the above objective, yet another aspect of the present disclosure also provides an oral care device, which at least includes a base station unit and an oral cleaner, where the base station unit is communicated with the oral cleaner by means of a conveying tube. The base station unit can convey a liquid to the oral cleaner by means of the conveying tube, such that the liquid is sprayed out of a cleaning head of the oral cleaner.

To achieve the above objective, still another aspect of the present disclosure also provides a vibration damping structure, which at least includes a strut member, a first connector and a first connecting arm, where a first notch is provided in the middle of the strut member, and the first notch penetrates through the strut member. The first connector is positioned within the first notch and is connected to the strut member by means of the first connecting arm, where the first connecting arm has a bending section.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic structural diagram of an oral care device according to an embodiment of the present disclosure;

FIG. 2 is a schematic structural semi-sectional view of a base station unit according to an embodiment of the present disclosure;

FIG. 3 is a schematic top view of a partial structure of the base station unit according to an embodiment of the present disclosure;

FIG. 4 is a schematic bottom view of a partial structure of the base station unit according to an embodiment of the present disclosure;

FIG. 5 is a schematic diagram of a connection state between a first connector and a first connecting arm according to an embodiment of the present disclosure;

FIG. 6 is a schematic top view of another partial structure of the base station unit according to an embodiment of the present disclosure;

FIG. 7 is a schematic structural diagram of a first power assembly according to an embodiment the present disclosure;

FIG. 8 is a schematic top view of a partial structure of the base station unit according to another embodiment of the present disclosure;

FIG. 9 is a schematic bottom view of a partial structure of the base station unit according to another embodiment of the present disclosure;

FIG. 10 is a schematic semi-sectional diagram of a first load-bearing member according to another embodiment of the present disclosure;

FIG. 11 is a schematic diagram from a first angle of a first covering member according to an embodiment of the present disclosure;

FIG. 12 is a schematic diagram from a second angle of the first covering member according to an embodiment of the present disclosure;

FIG. 13 is a schematic bottom view of another partial structure of the base station unit according to an embodiment of the present disclosure;

FIG. 14 is a schematic diagram after the first power assembly is connected to a second load-bearing member according to an embodiment of the present disclosure;

FIG. 15 is a schematic bottom view of a partial structure of the base station unit according to yet another embodiment of the present disclosure;

FIG. 16 is a schematic semi-sectional diagram after the first power assembly is connected to the second load-bearing member according to yet another embodiment of the present disclosure;

FIG. 17 is a schematic diagram from a first angle of a partial structure of the second load-bearing member according to an embodiment of the present disclosure;

FIG. 18 is a schematic diagram from a second angle of the partial structure of the second load-bearing member according to an embodiment of the present disclosure;

FIG. 19 is a schematic upward view of the partial structure of the second load-bearing member according to another embodiment of the present disclosure; and

FIG. 20 is a schematic structural diagram of a second covering member according to an embodiment the present disclosure.

Reference numerals in the accompanying drawings:

base station unit 1000; oral cleaner 2000;
main shell body 100; accommodating chamber 110; first cavity 111; second cavity 112;
first load-bearing member 200; strut member 210; first notch 211; fixing hole 212; step slot 213; first connector 220; intermediate frame 221; first connecting pole 222; first connecting arm 230; first covering member 240; annular groove 241; reinforcing rib 242;
first power assembly 300; drive module 310; mounting pole 311; motor frame 312; transmission module 320; water pumping module 330;
second load-bearing member 400; second connector 410; second connecting arm 420; third connector 430; connection part 431; connecting seat 440; seat body 441; second notch 4411; second connecting pole 442; third connecting arm 443; second covering member 444; and
liquid storage module 500.

### DETAILED DESCRIPTION

With the development of oral cleaning devices, more and more oral cleaning devices with different functions have emerged, such as oral irrigators only having rinsing functions, and integrated rinsers both having rinsing functions and brushing functions. When the above devices perform the rinsing functions, a base station unit is required to supply water flow to output water flow impact, to wash away substances harmful to dental health, such as food residue, bacteria, dental calculus or teeth stains attached to teeth or gums, thereby achieving oral health and care.

In related technologies, to fix a motor and a water pump, generally the motor and the water pump are directly connected to an outer shell body of the base station unit. The base station unit needs to use power of the motor to drive the water pump to pump and drain water when conveying the water flow. However, during operation, the motor and the water pump may generate vibration and noise. The vibration of the motor and the water pump may be directly transmitted to the outer shell body, thereby driving the outer shell body to vibrate together and thus increasing generation of the noise, which adversely affects user experience.

In response to the above technical problems, an inventor of the present disclosure proposes to connect the motor and the water pump to an internal shell body by means of a connecting arm, to suspend the motor and the water pump by means of the connecting arm, which can avoid the vibration of the motor and the water pump from being directly transmitted to the outer shell body. Moreover, vibration energy may be absorbed by means of deformation of the elongated connecting arm having a curved part, thereby further reducing transmission of the vibration of the motor and the water pump. In this way, generation of the noise is reduced, and the user experience is improved. Meanwhile, soft rubber is also wrapped between the connecting arm and the internal shell body, such that good elasticity and damping characteristics of the soft rubber are utilized to absorb and reduce the vibration transmitted from the motor and the water pump to the outer shell body, thereby further reducing the noise and improving operational stability of the base station unit.

To make the objectives, technical solutions, and advantages of the embodiments of the present disclosure clearer, the technical solutions in the embodiments of the present disclosure will be described clearly and completely below, in conjunction with the accompanying drawings in the embodiments of the present disclosure. Apparently, the described embodiments are some but not all of the embodiments of the present disclosure.

The present disclosure provides a base station unit 1000, which may be used as a separate component in conjunction with an oral cleaner 2000, to provide a liquid for rinsing to the oral cleaner 2000. Of course, a charging module may also be integrated on the base station unit 1000, such that the base station unit 1000 charges the oral cleaner 2000 by means of the charging module, which is not specifically limited in the present disclosure.

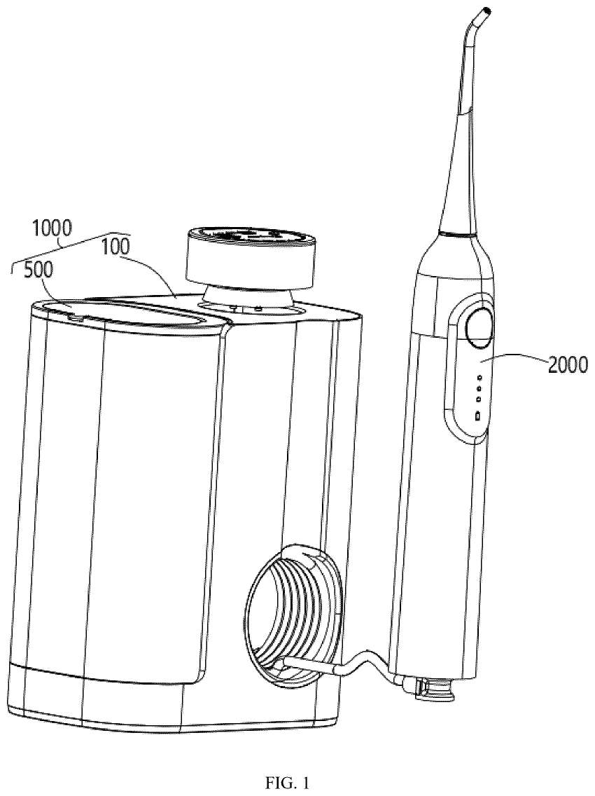

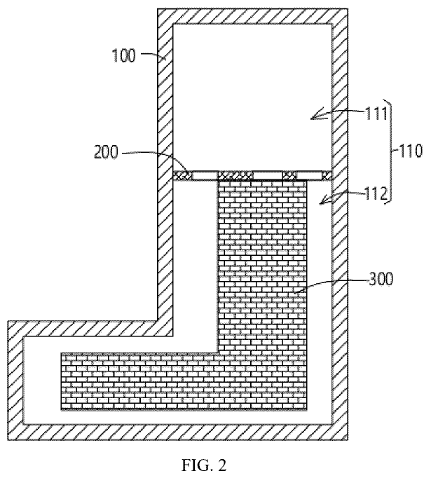

Referring to FIG. 1 and FIG. 2, in an implementable embodiment, the base station unit 1000 may at least include a main shell body 100, which serves as a main body of the base station unit 1000. The main shell body 100 may provide support and protection to other components of the base station unit 1000 except for the main shell body 100. The main shell body 100 may be a hollow structure, and an accommodating chamber 110 is formed inside the main shell body 100.

In this embodiment, the base station unit 1000 may also include a first load-bearing member 200 and a first power assembly 300, where the first load-bearing member 200 is positioned within the accommodating chamber 110. The first load-bearing member 200 is connected to the main shell body 100, and divides the accommodating chamber 110 into a first cavity 111 positioned above and a second cavity 112 positioned below. The first cavity 111 may be used to accommodate a control assembly of the base station unit 1000, and the second cavity 112 may be used to accommodate the first power assembly 300. Therefore, when the first power assembly 300 or a tube connected thereto accidentally leaks liquid, possibility of the liquid seeping into the first cavity 111 may be reduced because the first cavity 111 is positioned above the second cavity 112, which can avoid failure propagation.

Serving as a power source of the base station unit 1000, the first power assembly 300 may extract and discharge the liquid based on control of the control assembly. The first power assembly 300 is connected to the first load-bearing member 200 and suspended in the second cavity 112. That is, there is a predetermined height between the first power assembly 300 and a bottom of the main shell body 100, and the first power assembly 300 is suspended with respect to the bottom of the main shell body 100. In this way, an air or space gap may be formed between the first power assembly 300 and the bottom of the main shell body 100, where this gap may serve as a vibration isolation layer to prevent vibration of the first power assembly 300 from directly transmitting to the bottom of the main shell body 100 in contact with a placement tabletop of the base station unit 1000, thereby reducing the vibration transmitted to the main shell body 100.

Meanwhile, when the first power assembly 300 operates, the vibration generated by the first power assembly 300 first acts on the first load-bearing member 200, rather than is directly transmitted to the main shell body 100. In this way, the vibration energy generated by the deformation of the first load-bearing member 200 during vibration may be absorbed, thereby reducing the vibration transmitted from the first power assembly 300 to the main shell body 100 by means of the first load-bearing member 200. In this way, as the vibration of the main shell body 100 decreases, the noise generated by the vibration of the main shell body 100 may be reduced, thereby improving the user experience.

It should be pointed out that an up-down direction defined in the present disclosure refers to a direction in which the base station unit 1000 shown in FIG. 1 is placed, that is, an up-down direction when the base station unit 1000 is in a normal service condition.

In an implementable embodiment, the base station unit 1000 may also include a liquid storage module 500, and the first power assembly 300 is used to extract a liquid from the liquid storage module 500 and drain the liquid to the oral cleaner 2000, thereby achieving an oral rinsing function.

In practical applications, the liquid storage module 500 may be enclosed by the main shell body 100 to form a liquid storage cavity having the function of accommodating the liquid. As a separate water tank, the liquid storage module 500 may also be detachably installed on the main shell body 100. For example, the main shell body 100 has an accommodating groove formed by sinking from top to place the liquid storage module 500. The main shell body 100 may be detachably installed into the accommodating groove. When the liquid storage module 500 is installed into the accommodating groove, the first power assembly 300 may be communicated with inside of the liquid storage module 500, making it easier to extract the liquid from the liquid storage module 500. The accommodating groove may limit the main shell body 100 to from an L-shaped structure, and correspondingly, the accommodating chamber 110 may also be L-shaped. The first cavity 111 may be formed by an upper part of a vertical cavity of the L-shaped accommodating chamber 110, and the second cavity 112 may be formed by a lower part of the vertical cavity of the L-shaped accommodating chamber 110 and a horizontal cavity of the accommodating chamber 110. The first power assembly 300 may extend from the lower part of the vertical cavity of the accommodating chamber 110 to the horizontal cavity of the accommodating chamber 110.

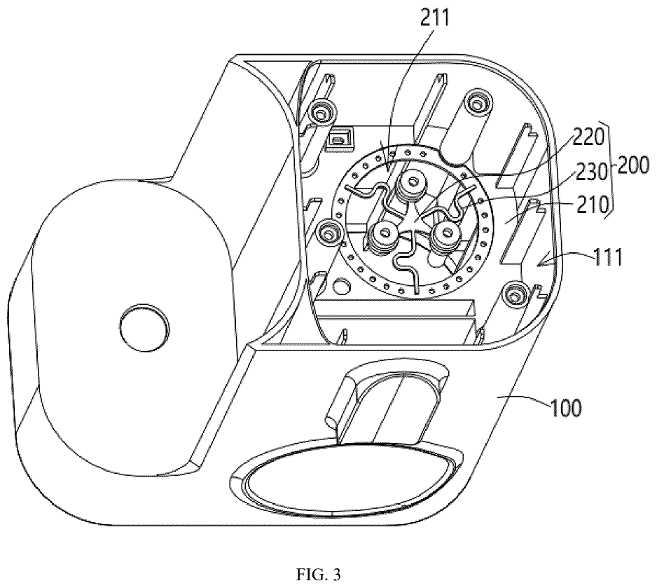

Regarding a specific structure of the first load-bearing member 200, as shown in FIGS. 3 to 6, in an implementable embodiment, the first load-bearing member 200 may include a strut member 210, a first connector 220, and a first connecting arm 230. Number of the first connecting arms 230 may be one, two, or more. The strut member 210 is connected to the main shell body 100. In this way, the first load-bearing member 200 is connected to the main shell body 100. A middle region of the strut member 210 is provided with a first notch 211 that penetrates through the strut member 210, and the first cavity 111 may be communicated with the second cavity 112 by means of the first notch 211. The first connector 220 is at least partially positioned within the first notch 211, and the first connector 220 is connected to the strut member 210 by means of the first connecting arm 230, where the first power assembly 300 is connected to the first connector 220. The first connecting arm 230 may deform after it is subjected to force, and the vibration energy is absorbed by means of the deformation of the first connecting arm 230, thereby reducing the vibration transmitted from the first power assembly 300 to the main shell body 100 by means of the first load-bearing member 200. Moreover, the first connector 220 connected to the first power assembly 300 is connected to the strut member 210 by means of the first connecting arm 230. There is a gap between the first connector 220 and the strut member 210, which can effectively isolate the vibration and reduce the transmission of the vibration between the first power assembly 300 and the main shell body 100. Meanwhile, preferably two or more first connecting arms 230 are provided, and the first connector 220 is connected to the strut member 210 by means of at least two first connecting arms 230, to avoid unstable unilateral connection, thereby ensuring stability of connection between the first power assembly 300 and the strut member 210.

In this embodiment, the first connecting arm 230 may have an elongated structure, and the first connecting arm 230 may be made of hard rubber material. The first connecting arm 230 achieves the deformation by means of its own shape characteristics, to absorb the vibration energy by means of the deformation, thereby reducing the vibration transmitted from the first power assembly 300 to the main shell body 100. Meanwhile, the first connecting arm 230 is made of hard rubber material and may also have certain strength, thereby avoiding problems of fracture under stress and permanent deformation. Of course, the first connecting arm 230 may also be made of other materials having certain strength and a certain degree of deformation.

In practical applications, the strut member 210 may be directly or indirectly connected to the main shell body 100. When the strut member 210 is directly connected to the main shell body 100, the main shell body 100, the strut member 210, the first connector 220, and the first connecting arm 230 may be integrally formed by means of injection moulding or the like, thereby simplifying production processes and reducing production costs. Furthermore, stability and reliability of connection between the main shell body 100, the strut member 210, the first connector 220, and the first connecting arm 230 can be ensured. Of course, the main shell body 100 may also be integrally formed with a portion of the strut member 210, the first connector 220 and the first connecting arm 230, or the main shell body 100, the strut member 210, the first connector 220, and the first connecting arm 230 may be separately formed and then connected to each other.

Further, the first connecting arm 230 may have at least one bending section. That is, the first connecting arm 230 has a bending design, such that range of the deformation of the first connecting arm 230 may be further increased by means of the bending design, which can improve vibration damping effects of the first connecting arm 230.

In practical applications, number of the bending sections of the first connecting arm 230 may be one, two, three, or four, etc. When the first connecting arm 230 has one bending section, the first connecting arm 230 may take the shape of “Ω”, as shown in FIG. 5.

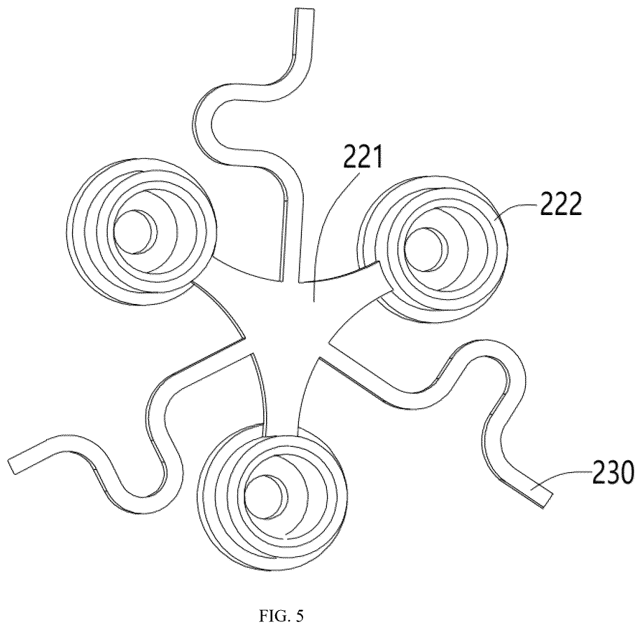

As shown in FIG. 5 and FIG. 6, in an implementable embodiment, the first connector 220 may include an intermediate frame 221 and a first connecting pole 222. The first power assembly 300 is connected to the first connecting pole 222, and number of the first connecting poles 222 may be one, two, or more. Preferably two or more first connecting poles 222 are provided, at least two first connecting poles 222 connected to an edge of the intermediate frame 221, and at least two first connecting arms 230 are connected to at least two first connecting poles 222 by means of the intermediate frame 221. In this way, compared to the manner of connecting each first connecting pole 222 to the strut member 210 by means of the first connecting arm 230, in the present disclosure, at least two first connecting poles 222 are connected to the intermediate frame 221, and the intermediate frame 221 is connected to the strut member 210 by means of the first connecting arm 230. In this way, the structure of the first load-bearing member 200 may be simplified.

Meanwhile, the first connecting pole 222 connected to the first power assembly 300 is connected to the edge of the intermediate frame 221. That is, the intermediate frame 221 does not completely surround the first connecting pole 222. In this way, there exists an unconnected region between a circumferential direction of the first connecting pole 222 and the intermediate frame 221, which can further reduce the transmission of the vibration of the first power assembly 300 along the circumferential direction of the first connecting pole 222.

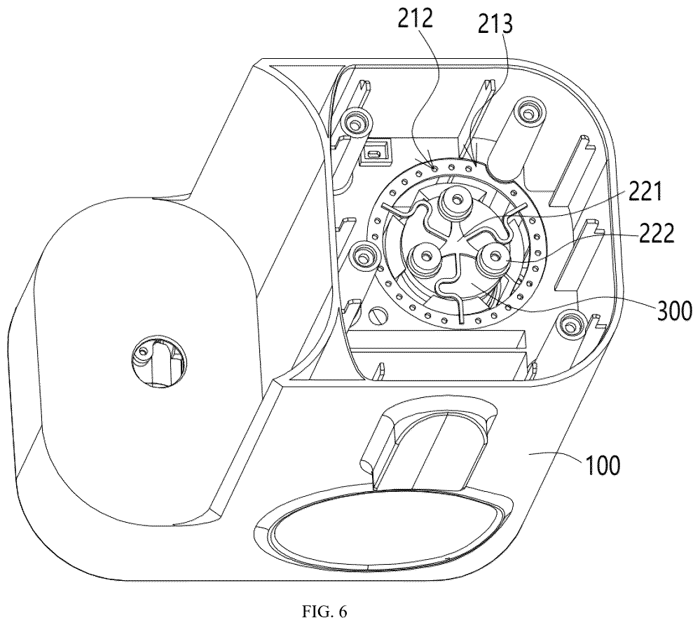

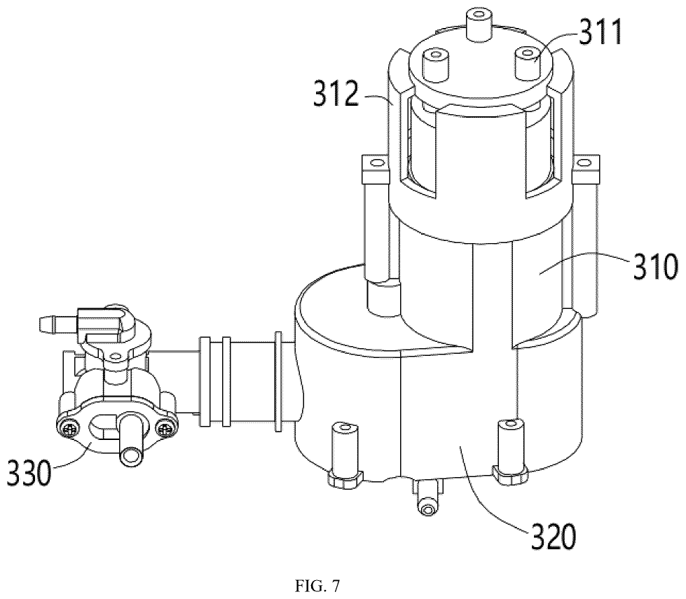

In practical applications, as shown in FIG. 7, a top of the first power assembly 300 may be provided with a mounting pole 311, and the first connecting pole 222 is provided with an inner cavity for accommodating the mounting pole 311. The mounting pole 311 may be connected, in the inner cavity of the first connecting pole 222, to the first connecting pole 222 by means of clamping, bonding, interference fit, or screw fastening, etc.

A shape of the first notch 211 may be triangular, circular, square, or the like.

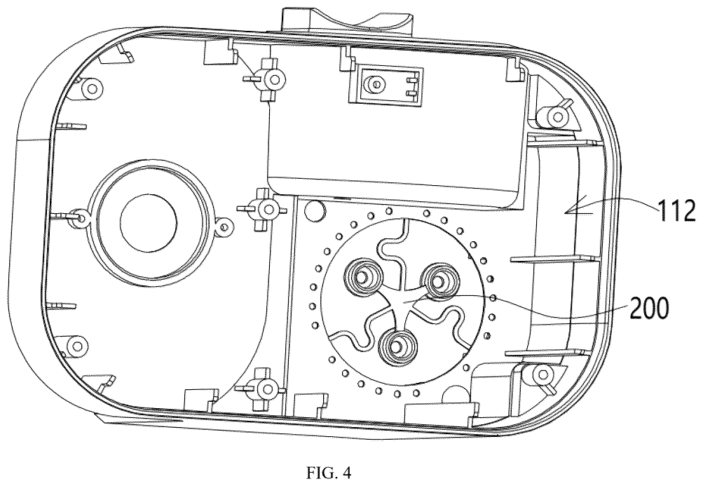

As shown in FIG. 3 and FIG. 4, taking an example where the first notch 211 is roughly circular, the number of the first connecting poles 222 may be equal to that of the first connecting arms 230, and at least two first connecting poles 222 and at least two first connecting arms 230 are alternately arranged in sequence and are arranged in an annular array with respect to an axis of the first notch 211. That is, there exists one first connecting arm 230 between two adjacent first connecting poles 222, and the two adjacent first connecting poles 222 are symmetrically arranged with respect to the first connecting arm 230 positioned between the two adjacent first connecting poles 222. In this way, uniformity and stability of supporting the first connector 220 by the first connecting arm 230 may be ensured. Meanwhile, the vibration from the first power assembly 300 may be uniformly transmitted to the first notch 211 by means of the first connecting pole 222 and the first connecting arm 230, such that the vibration is evenly distributed on the main shell body 100, thereby avoiding the problem of excessive noise caused by concentration of the vibration.

It should be pointed out that the first notch 211 may be a complete circle. However, in an actual design process, in most cases, limited by components inside the main shell body 100, the first notch 211 forms a corresponding inward or outward extending region, which is a quasi-circle in shape. Either the complete circle or the quasi-circle is the roughly circular shape as defined above.

The number of the first connecting poles 222 and the number of the first connecting arms 230 may be two, three, four, five, and so on. For example, three first connecting poles 222 and three first connecting arms 230 are provided, each of the three first connecting arms 230 is separately connected to a side wall of the intermediate frame 221 between two adjacent first connecting poles 222.

In practical applications, the intermediate frame 221 may be similarly shaped like a triangle, where the three first connecting poles 222 are separately connected to three vertexes of the intermediate frame 221, and the three first connecting arms 230 are separately connected to midpoints of three side edges of the intermediate frame 221. The three side edges of the intermediate frame 221 may also take the shape of inward concave arcs, allowing the intermediate frame 221 to have certain deformability, such that the vibration energy is absorbed by means of the deformation of the intermediate frame 221, thereby reducing the vibration transmitted from the first power assembly 300 to the main shell body 100 by means of the first load-bearing member 200.

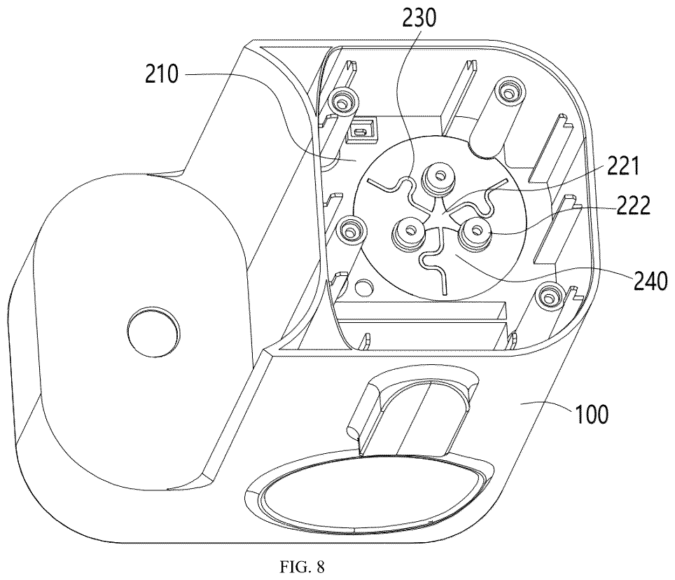

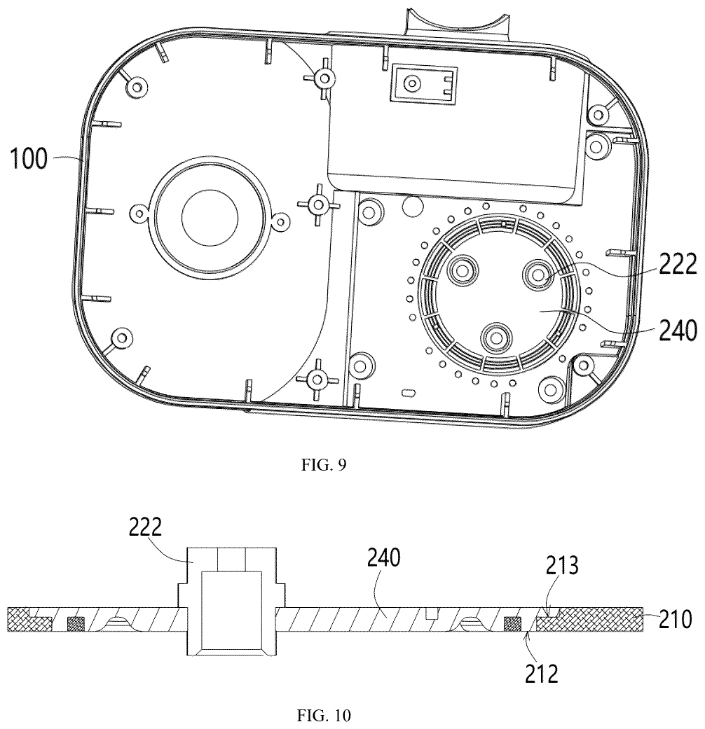

To further reduce the vibration transmitted from the first power assembly 300 to the main shell body 100 by means of the first load-bearing member 200, as shown in FIG. 8 and FIG. 9, in an implementable embodiment, the first load-bearing member 200 may also include a first covering member 240 made of soft rubber. As a material having elasticity and flexibility, the soft rubber may be made of various different polymer materials, such as natural or synthetic rubber, silicone rubber, thermoplastic elastomer (TPE), thermoplastic polyurethane (TPU), or soft PVC, etc. The first covering member 240 at least partially covers at least one of the strut member 210, the first connector 220, and the first connecting arm 230. In this way, when the vibration of the first power assembly 300 is transmitted by means of the first connector 220, the first connecting arm 230 and the strut member 210, the first covering member 240 can absorb the vibration by means of its own elasticity and damping characteristics, thereby reducing the transmission of the vibration. Meanwhile, the first covering member 240 may connect the strut member 210, the first connector 220, and the first connecting arm 230 to each other, to ensure stability of connection between the strut member 210, the first connector 220 and the first connecting arm 230, avoiding fracture or permanent deformation damage caused by the vibration, thereby prolonging service life of the first load-bearing member 200.

In practical applications, after the strut member 210, the first connector 220 and the first connecting arm 230 are integrally formed or connected to each other based on separate design, the first covering member 240 may cover at least one of the strut member 210, the first connector 220 and the first connecting arm 230 by means of secondary injection moulding or nesting.

The first covering member 240 may partially fill a hollowed-out region between the strut member 210, the first connector 220, and the first connecting arm 230.

The first covering member 240 may also completely fill the hollowed-out region between the strut member 210, the first connector 220, and the first connecting arm 230. Correspondingly, an outer peripheral surface of the strut member 210 is seamlessly connected to an inner wall surface of the main shell body 100, such that the first load-bearing member 200 can isolate the first cavity 111 and the second cavity 112 from each other, which can further avoid the possibility of accidental liquid leakage from the second cavity 112 to the first cavity 111, thus reducing the failure propagation.

In practical applications, the first covering member 240 can completely cover the intermediate frame 221 and the first connecting arm 230, or the first covering member 240 may also only cover a side face and a bottom face of the intermediate frame 221 and of the first connecting arm 230. The first covering member 240 may only cover the side face of the first connecting pole 222, such that the vibration transmitted along the circumferential direction of the first connecting pole 222 may be reduced by the first covering member 240. To prevent disconnection of the first covering member 240 from the first connecting pole 222, an outer wall surface of the first connecting pole 222 is provided with an outwardly protruding annular flange, and the first covering member 240 is only covered below the annular flange. In this way, when the first power assembly 300 applies a downward force to the first connecting pole 222, the first covering member 240 may push against the annular flange to share the force, thereby reducing possibility of the disconnection of the first covering member 240 from the first connecting pole 222.

As shown in FIG. 6, FIG. 8 and FIGS. 10 to 12, in an implementable embodiment, the strut member 210 may be provided with a plurality of fixing holes 212 spaced around an edge of the first notch 211, and the first covering member 240 fills the plurality of fixing holes 212, which can increase area of contact between the first covering member 240 and the strut member 210. In this way, adhesive force between the first covering member 240 and the strut member 210 can be increased, the possibility of the disconnection of the first covering member 240 during multiple deformations can be avoided, and stability and reliability of the first covering member 240 can be improved.

In practical applications, the plurality of fixing holes 212 may be arranged in an annular array around the edge of the first notch 211, or the plurality of fixing holes 212 may also be at least partially unevenly spaced around the first notch 211, which is not specifically limited in the present disclosure.

It is to be understood that when a fixing hole 212 is arranged on the strut member 210, the fixing hole 212 may be understood as the hollowed-out region on the strut member 210. Correspondingly, when the first load-bearing member 200 needs to isolate the first cavity 111 and the second cavity 112 from each other, the first covering member 240 not only needs to completely fill the hollowed-out region between the strut member 210, the first connector 220, and the first connecting arm 230, but also needs to fill the fixing hole 212. That is, the hollowed-out region on the strut member 210 needs to be filled.

Further, the strut member 210 may be provided with a step slot 213, which is arranged around the edge of the first notch 211, where an inner wall surface of the step slot 213 is communicated with the first notch 211. The plurality of fixing holes 212 are formed at a bottom of the step slot 213, and the first covering member 240 fills the step slot 213. In this way, the area of contact between the first covering member 240 and the strut member 210 is further increased, and the adhesive force between the first covering member 240 and the strut member 210 is further increased. Meanwhile, arrangement of the step slot 213 may also ensure that top and bottom surfaces of the first covering member 240 and of the strut member 210 are roughly flush, to ensure overall aesthetic of the first load-bearing member 200.

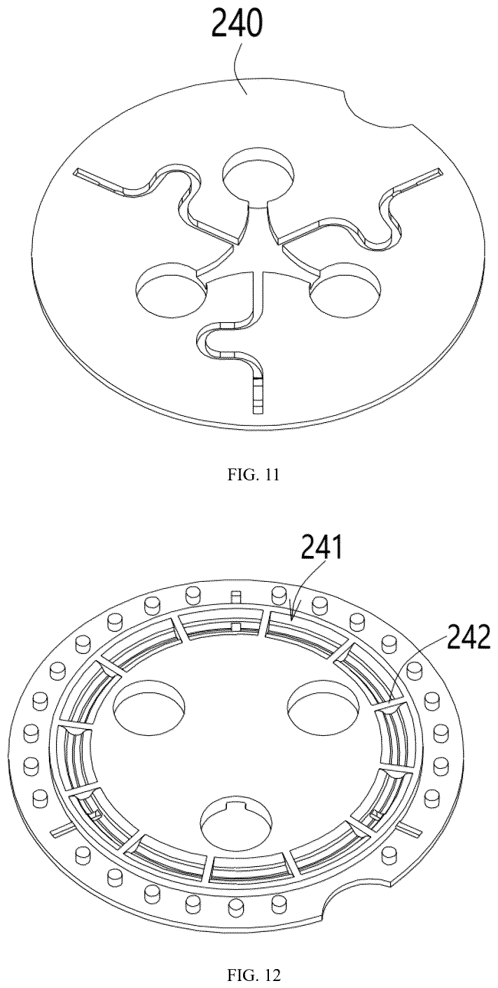

As shown in FIG. 12, in an implementable embodiment, the bottom surface of the first covering member 240 is provided with an annular groove 241, which is positioned within the first notch 211 and is arranged around the edge of the first notch 211. The annular groove 241 is internally provided with a plurality of reinforcing ribs 242 arranged in an annular array along the annular groove 241. By increasing strength of the first covering member 240 by means of the reinforcing ribs 242, the first covering member 240 can better withstand long-term or repeated loads, thereby extending its service life. Furthermore, the first covering member 240 having higher strength can provide better support for the first power assembly 300, to reduce the deformation under high load conditions, thereby improving the stability of the first load-bearing member 200.

Regarding the specific structure of the first power assembly 300, as shown in FIG. 7, in an implementable embodiment, the first power assembly 300 may include a drive module 310, a transmission module 320, and a water pumping module 330. A top of the drive module 310 is connected to the first load-bearing member 200, and a bottom of the drive module 310 is connected to the water pumping module 330 by means of the transmission module 320. Therefore, the drive module 310 may drive, by means of the transmission module 320, the water pumping module 330 to operate, to extract and drain the liquid from the liquid storage module 500.

In this embodiment, the drive module 310 and the water pumping module 330 may be connected by means of the transmission module 320 to form an integrated body, and may be installed on the base station unit 1000 or dismantled from the base station unit 1000 integrally. The drive module 310 is positioned within the vertical cavity of the second cavity 112, the transmission module 320 is positioned at a junction between the vertical cavity and the horizontal cavity of the second cavity 112, and the water pumping module 330 is positioned within the horizontal cavity of the second cavity 112.

In practical applications, the drive module 310 may be a motor, the transmission module 320 may be a gearbox, and the water pumping module 330 may be a water pump. A motor frame 312 is installed on the motor, and correspondingly, the mounting pole 311 is formed on the motor frame 312.

To ensure a position of the water pumping module 330 to be relatively fixed and to avoid adversely affecting normal operation of the water pumping module 330, the water pumping module 330, or the junction between the water pumping module 330 and the transmission module 320, is connected to the main shell body 100 by means of a second load-bearing member 400. Meanwhile, the second load-bearing member 400 limits one end of the first power assembly 300 positioned on the water pumping module 330, which can prevent the water pumping module 330 from generating large amplitude vibration, thereby reducing the vibration and noise.

In practical applications, to ensure that the first power assembly 300 is suspended in the second cavity 112, the second load-bearing member 400 is connected to a portion of the main shell body 100 positioned above or on a side face of the water pumping module 330, such that the water pumping module 330 is still suspended with respect to the bottom of the main shell body 100.

Regarding the specific structure of the second load-bearing member 400, the present disclosure provides two implementable embodiments for reference.

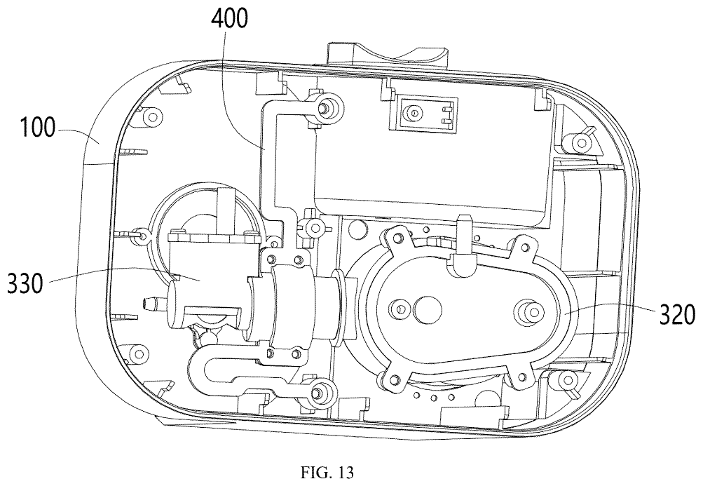

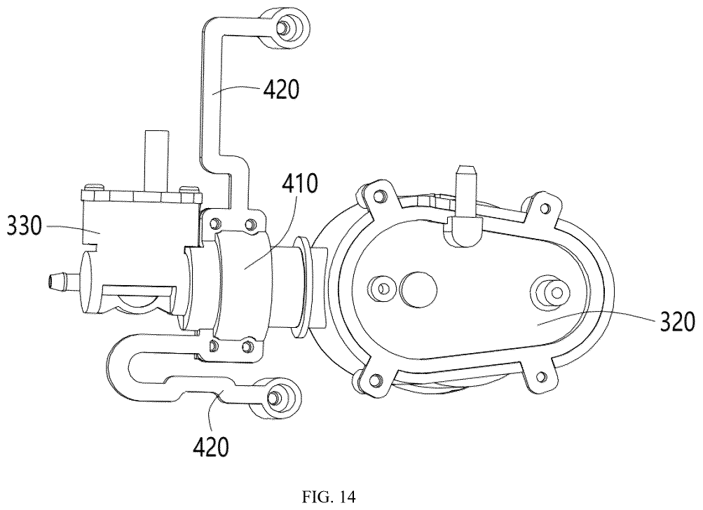

In Embodiment I, as shown in FIG. 13 and FIG. 14, the second load-bearing member 400 includes a second connector 410 and a second connecting arm 420, where the second connector 410 is connected to the water pumping module 330, or the second connector 410 is connected to the junction between the water pumping module 330 and the transmission module 320. One end of the second connecting arm 420 is connected to the second connector 410, and the other end of the second connecting arm 420 is connected to the main shell body 100. The second connecting arm 420 also has at least one bending section.

In this embodiment, the second connecting arm 420 may have an elongated structure, and the second connecting arm 420 may be made of hard rubber material. The second connecting arm 420 implements deformation by utilizing its own shape characteristics to absorb the vibration energy by means of the deformation, thereby reducing the vibration transmitted from the water pumping module 330 to the main shell body 100. Meanwhile, the second connecting arm 420 may be made of hard rubber material, which has certain strength, to avoid the problems of fracture under stress and permanent deformation. Of course, the second connecting arm 420 may also be made of other materials having certain strength and generating certain degree of deformation.

In practical applications, the second connector 410 may take the shape of a sleeve, and the second connector 410 is sleeved on the water pumping module 330 or sleeved at the junction between the water pumping module 330 and the transmission module 320. The second connector 410 may also be shaped like a sleeve formed by splicing two circular arc pieces together, which is not specifically limited in the present disclosure. The second connecting arm 420 may be directly or indirectly connected to the main shell body 100. When the second connecting arm 420 is directly connected to the main shell body 100, the main shell body 100 and the second connecting arm 420 may be integrally formed by means of injection moulding or the like. In this way, the production processes are simplified, and the production costs are reduced. Of course, when the second connecting arm 420 is directly connected to the main shell body 100, the second connecting arm 420 may also be connected to the main shell body 100 by means of clamping, hot melting, adhesive gluing, and thread fastening or the like, which is not specifically limited in the present disclosure.

Further, the second connecting arm 420 may have at least one bending section. That is, the second connecting arm 420 has a bending design, such that range of the deformation of the second connecting arm 420 may be further increased by means of the bending design, which can improve the vibration damping effects of the second connecting arm 420.

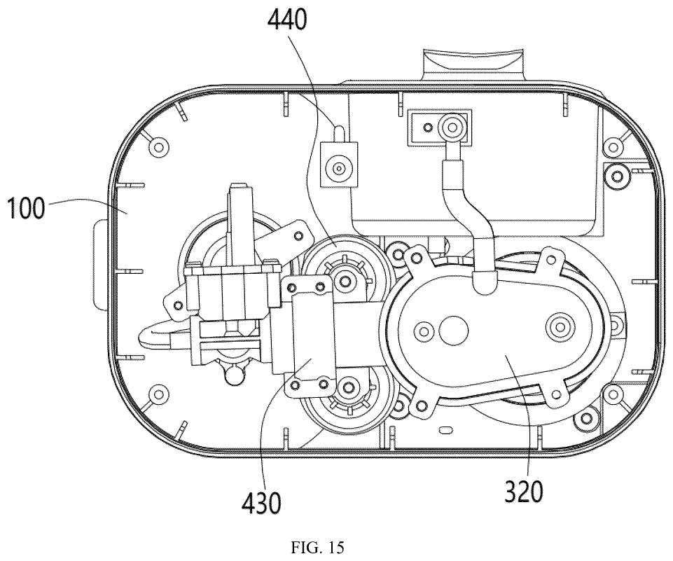

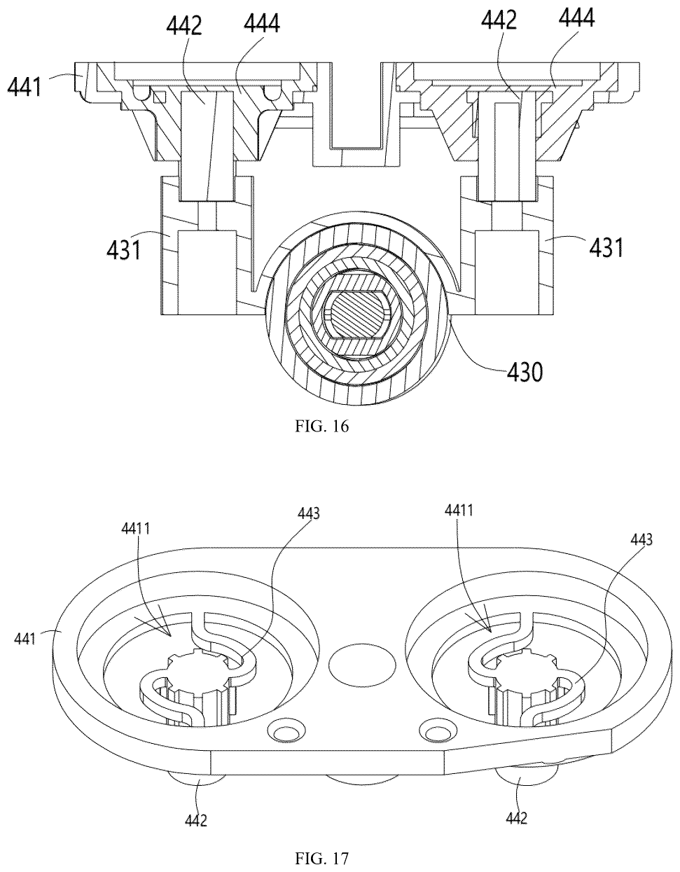

In Embodiment II, as shown in FIG. 15 and FIG. 16, the second load-bearing member 400 includes a third connector 430 and a connecting seat 440. The third connector 430 is connected to the water pumping module 330, or the third connector 430 is connected to the junction between the water pumping module 330 and the transmission module 320. The third connector 430 is connected to the main shell body 100 by means of the connecting seat 440.

When the water pumping module 330 is running, the vibration generated by the first power assembly 300 positioned at the water pumping module 330, or the vibration generated by the water pumping module 330, first acts on the second load-bearing member 400, rather than being directly transmitted to the main shell body 100. In this way, the second load-bearing member 400 may deform when it is subjected to vibration, and the deformation may absorb the vibration energy, thereby reducing the vibration transmitted from the water pumping module 330 to the main shell body 100 by means of the second load-bearing member 400. In this way, as the vibration of the main shell body 100 decreases, the noise generated by the vibration of the main shell body 100 may be reduced, thereby improving the user experience.

In practical applications, the third connector 430 may take the shape of a sleeve, and the third connector 430 is sleeved on the water pumping module 330 or sleeved at the junction between the water pumping module 330 and the transmission module 320. The third connector 430 may also be shaped like a sleeve formed by splicing two circular arc pieces together, which is not specifically limited in the present disclosure.

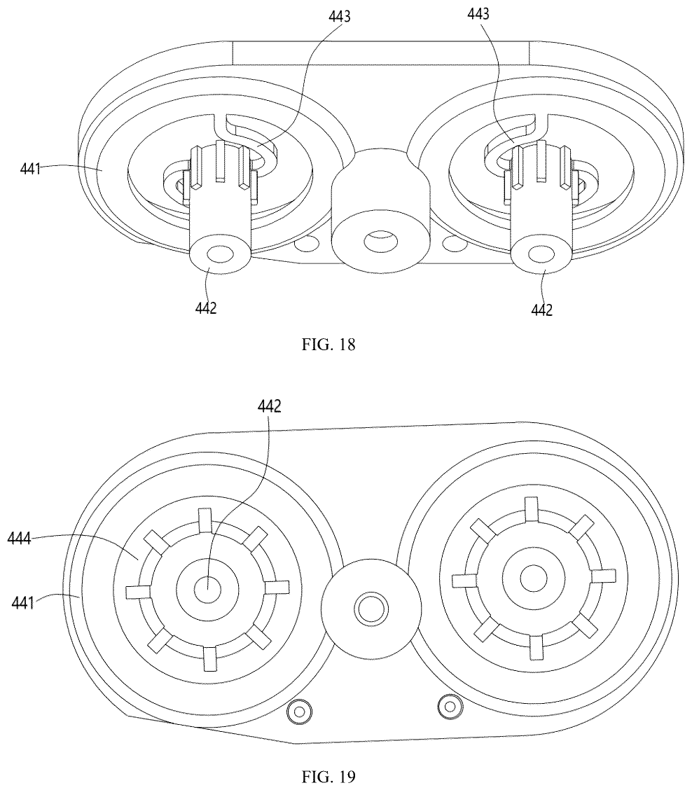

As shown in FIGS. 16 to 18, in an implementable embodiment, the connecting seat 440 may include a seat body 441, a second connecting pole 442, and a third connecting arm 443. The number of the third connecting arms 443 may be one, two, or more. The seat body 441 is connected to the main shell body 100, and a second notch 4411 is provided on the seat body 441. The second connecting pole 442 is at least partially positioned within the second notch 4411. One end of the second connecting pole 442 is connected to the seat body 441 by means of the third connecting arm 443, and other end of the second connecting pole 442 is connected to the third connector 430. The vibration energy is absorbed by utilizing the deformation of the third connecting arm 443, thereby reducing the vibration transmitted from the water pumping module 330 to the main shell body 100 by means of the connecting seat 440.

Moreover, preferably the number of the third connecting arms 443 is two or more, and the second connecting pole 442 is connected to the seat body 441 by means of at least two third connecting arms 443. There exists a gap between the second connecting pole 442 and the seat body 441. The transmission of the vibration between the second connecting pole 442 and the main shell body 100 may be reduced by means of effective vibration isolation of the gap. Meanwhile, the second connecting pole 442 is connected to the seat body 441 by means of at least two third connecting arms 443, to avoid unstable unilateral connection, thereby ensuring stability of the connection between the seat body 441 and the second connecting pole 442.

In this embodiment, the third connecting arm 443 may have an elongated structure, and the third connecting arm 443 may be made of hard rubber material. The third connecting arm 443 achieves the deformation by means of its own shape characteristics, to absorb the vibration energy by means of the deformation, thereby reducing the vibration transmitted from the water pumping module 330 of the first power assembly 300 to the main shell body 100. Meanwhile, the third connecting arm 443 is made of hard rubber material and may also have certain strength, thereby avoiding the problems of fracture under stress and permanent deformation. Of course, the third connecting arm 443 may also be made of other materials having certain strength and a certain degree of deformation.

In practical applications, the seat body 441, the second connecting pole 442, and the third connecting arm 443 may all be made of the hard rubber material and may be integrally formed by means of injection moulding, thereby simplifying the production processes and reducing the production costs. Furthermore, stability and reliability of the connection between the seat body 441, the second connecting pole 442, and the third connecting arm 443 can be ensured.

Further, the third connecting arm 443 may have at least one bending section. That is, the third connecting arm 443 has a bending design, such that range of the deformation of the third connecting arm 443 may be further increased by means of the bending design, which can improve the vibration damping effects of the third connecting arm 443.

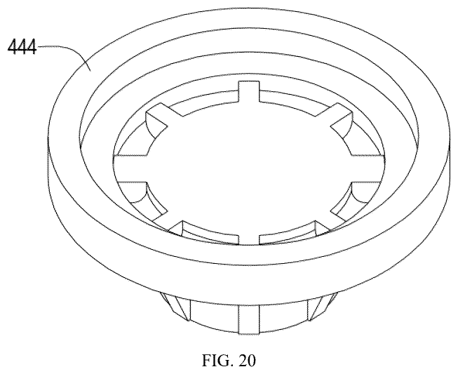

As shown in FIGS. 16 to 20, in an implementable embodiment, the connecting seat 440 may also include a second covering member 444 made of soft rubber. The second covering member 444 at least partially covers at least one of the seat body 441, the second connecting pole 442, and the third connecting arm 443. It should be pointed out that as a material having elasticity and flexibility, the soft rubber may be made of various different high molecular polymers, such as natural or synthetic rubber, silicone rubber, thermoplastic elastomer (TPE), thermoplastic polyurethane (TPU), or soft PVC, etc.

When the water pumping module 330 of the first power assembly 300 transmits the vibration by means of the second connecting pole 442, the third connecting arm 443, and the seat body 441, the second covering member 444 can absorb the vibration by means of its own elasticity and damping characteristics, thereby reducing the transmission of the vibration. Meanwhile, the second covering member 444 may connect the second connecting pole 442, the third connecting arm 443 and the seat body 441 to each other, to ensure stability of the connection between the second connecting pole 442, the third connecting arm 443 and the seat body 441, avoiding fracture or permanent deformation damage caused by the vibration, thereby prolonging the service life of the second load-bearing member 400.

In practical applications, after the second connecting pole 442, the third connecting arm 443, and the seat body 441 are integrally formed or connected to each other based on separate design, the second covering part 444 may cover the second connecting pole 442, the third connecting arm 443, and the seat body 441 by means of secondary injection moulding or nesting.

Further, the bottom surface of the second covering member 444 may be provided with an annular groove, which is positioned within the second notch 4411 and is arranged around the edge of the second notch 4411. The annular groove is internally provided with a plurality of reinforcement structures arranged in an annular array along the annular groove. By increasing strength of the second covering member 444 by means of the reinforcement structures, the second covering member 444 can better withstand long-term or repeated loads, thereby extending its service life. Furthermore, the second covering member 444 having higher strength can provide better support for the first power assembly 300, to reduce the deformation under high load conditions, thereby improving the stability of the second load-bearing member 400.

Further, the third connector 430 has two connection parts 431. Correspondingly, there are provided two second notches 4411, each of which is internally provided with the second connecting pole 442, the third connecting arm 443, and the second covering member 444. The two connection parts 431 are separately connected to the two second connecting poles 442. In this way, dual vibration damping effects are achieved, and it is ensured stability of limiting the second load-bearing member 400 to one end of the first power assembly 300 positioned on the water pumping module 330.

Based on the same inventive concept, the present disclosure also provides a base station unit 1000, which may include the main shell body 100, the first load-bearing member 200, and the first power assembly 300. The main shell body 100 has the accommodating chamber 110. The first load-bearing member 200 positioned within the accommodating chamber 110 includes a strut member 210, a first connector 220, and a first connecting arm 230. The strut member 210 is connected to the main shell body 100, and a middle of the strut member 210 is provided with a first notch 211 running through the strut member 210. The first connector 220 is positioned within the first notch 211 and is connected to the strut member 210 by means of the first connecting arm 230. The first power assembly 300 is connected to the first connector 220 and is suspended in the accommodating chamber 110.

It should be pointed out that reference may be made to the contents recorded in detail in the above embodiments for specific structures of the main shell body 100, the first load-bearing member 200 and the first power assembly 300, which are thus not to be described in detail here.

Based on the same inventive concept, the present disclosure also provides an oral care device, which at least includes the base station unit 1000 and the oral cleaner 2000 for oral cleaning. The base station unit 1000 is communicated with the oral cleaner 2000 by means of a conveying tube, and the base station unit 1000 can convey a liquid to the oral cleaner 2000 by means of the conveying tube, such that the liquid is sprayed out of a cleaning head of the oral cleaner 2000. The oral cleaner 2000 is either one of an integrated rinser and an oral irrigator.

When the oral cleaner 2000 is the integrated rinser, the cleaning head may be a brush head having bristles, a nozzle, or a brush head having both the bristles and the nozzle. The main body of the oral cleaner 2000 may be internally provided with a second power assembly, which includes a drive shaft for receiving the cleaning head, a motor body for rotating the drive shaft and/or applying vibration motion to the drive shaft. The drive shaft may be designed into a hollow structure to provide a fluid channel, such that a fluid may enter the cleaning head from the drive shaft to perform teeth rinsing operations.

In practical applications, the base station unit 1000 may also have a mounting position, and the oral cleaner 2000 may be detachably connected to the base station unit 1000 by means of magnetic adsorption, suspension, or fastening of the mounting position, such that when the oral cleaner 2000 is in idle, the oral cleaner 2000 may be stored and organized together with the base station unit 1000.

It should be pointed out that reference may be made to the contents recorded in detail in the above embodiments for the specific structure of the base station unit 1000, which is thus not to be described in detail here.

Based on the same inventive concept, the present disclosure also provides a vibration damping structure, which may be used in the base station unit 1000 of the oral care device mentioned above, and may also be used in devices such as the integrated rinsers or other devices that require vibration damping. Specifically, the vibration damping structure at least includes the strut member 210, the first connector 220, and the first connecting arm 230. The middle of the strut member 210 is provided with the first notch 211, which penetrates through the strut member 210. The first connector 220 is positioned within the first notch 211 and is connected to the strut member 210 by means of the first connecting arm 230, where the first connecting arm 230 has at least one bending section.

Further, the vibration damping structure also includes the first covering member 240 having elastic properties. The first covering member 240 at least partially covers at least one of the strut member 210, the first connector 220, and the first connecting arm 230.

It should be pointed out that reference may be made to the contents recorded in detail in the above embodiments for specific structures of the strut member 210, the first connector 220, the first connecting arm 230 and the first covering member 240, which are thus not to be described in detail here.

Finally, it is to be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, which does not make corresponding technical solutions in essence depart from the scope of the technical solutions of the embodiments of the present disclosure.

What is claimed is:

1. A base station unit comprising:
a main shell body (100) having an accommodating chamber (110);
a first load-bearing member (200) positioned within the accommodating chamber (110), the first load-bearing member (200) being connected to the main shell body (100) and being configured to divide the accommodating chamber (110) into a first cavity (111) positioned above and a second cavity (112) positioned below; and
a first power assembly (300) connected to the first load-bearing member (200) and suspended in the second cavity (112).

2. The base station unit according to claim 1, wherein the first load-bearing member (200) comprises a strut member (210), a first connector (220), and a first connecting arm (230);
the strut member (210) is connected to the main shell body (100), and a middle of the strut member (210) is provided with a first notch (211) running through the strut member (210); and
the first connector (220) is at least partially positioned within the first notch (211) and is connected to the strut member (210) by means of the first connecting arm (230), and the first power assembly (300) is connected to the first connector (220).

3. The base station unit according to claim 2, wherein the first connecting arm (230) has at least one bending section.

4. The base station unit according to claim 2, wherein the first connector (220) comprises an intermediate frame (221) and a first connecting pole (222) configured to connect the first power assembly (300); and
the first connecting pole 222 is connected to an edge of the intermediate frame (221), and the first connecting arm (230) is connected to the first connecting pole 222 by means of the intermediate frame (221).

5. The base station unit according to claim 4, wherein the first notch (211) is roughly circular; and
the first connecting poles (222) and the first connecting arms (230) are equal in number, and the first connecting poles (222) and the first connecting arms (230) are alternately arranged in sequence and are arranged in an annular array with respect to an axis of the first notch (211).

6. The base station unit according to claim 5, wherein both the number of the first connecting poles (222) and the number of the first connecting arms (230) are three, and the three first connecting arms (230) are separately connected to a side wall of the intermediate frame (221) positioned between adjacent two of the three first connecting poles (222).

7. The base station unit according to claim 2, wherein the main shell body (100), the strut member (210), the first connector (220), and the first connecting arm (230) are integrally formed.

8. The base station unit according to claim 2, wherein the first load-bearing member (200) further comprises a first covering member (240) made of soft rubber; and
the first covering member (240) at least partially covers at least one of the strut member (210), the first connector (220), and the first connecting arm (230).

9. The base station unit according to claim 8, wherein the strut member (210) is provided with a plurality of fixing holes (212); and
the plurality of fixing holes (212) are spaced around an edge of the first notch (211), and the first covering member (240) fills the plurality of fixing holes (212).

10. The base station unit according to claim 8, wherein an outer peripheral surface of the strut member (210) is seamlessly connected to an inner wall surface of the main shell body (100), and the first covering member (240) fills a hollowed-out region on the strut member (210) and a hollowed-out region between the strut member (210), the first connector (220) and the first connecting arm (230), to isolate the first cavity (111) from the second cavity (112).

11. The base station unit according to claim 1, wherein the first power assembly (300) comprises a drive module (310), a transmission module (320), and a water pumping module (330);
a bottom end of the drive module (310) is connected to the water pumping module (330) by means of the transmission module (320); and
the water pumping module (330) or a junction between the water pumping module (330) and the transmission module (320) is connected to the main shell body (100) by means of a second load-bearing member (400).

12. The base station unit according to claim 11, wherein the second load-bearing member (400) comprises a second connector (410) and a second connecting arm (420);
the second connector (410) is connected to the water pumping module (330), or the second connector (410) is connected to the junction between the water pumping module (330) and the transmission module (320); and
one end of the second connecting arm (420) is connected to the second connector (410), other end of the second connecting arm (420) is connected to the main shell body (100), and the second connecting arm (420) has at least one bending section.

13. The base station unit according to claim 11, wherein the second load-bearing member (400) comprises a third connector (430) and a connecting seat (440);
the third connector (430) is connected to the water pumping module (330), or the third connector (430) is connected to the junction between the water pumping module (330) and the transmission module (320); and
the connecting seat (440) has elastic properties, and the third connector (430) is connected to the main shell body (100) by means of the connecting seat (440).

14. The base station unit according to claim 13, wherein the connecting seat (440) comprises a seat body (441), a second connecting pole (442), and a third connecting arm (443);
the seat body (441) is connected to the main shell body (100), and a second notch (4411) is provided on the seat body (441); and
the second connecting pole (442) is at least partially positioned within the second notch (4411), one end of the second connecting pole (442) is connected to the seat body (441) by means of the third connecting arm (443), and other end of the second connecting pole (442) is connected to the third connector (430).

15. The base station unit according to claim 14, wherein the connecting seat (440) further comprises a second covering member (444) made of soft rubber; and
the second covering member (444) at least partially covers at least one of the seat body (441), the second connecting pole (442), and the third connecting arm (443).

16. The base station unit according to claim 15, wherein the third connector (430) has two connection parts (431); and
there are provided two second notches (4411), each of the two second notches (4411) is internally provided with the second connecting pole (442), the third connecting arm (443) and the second covering member (444), and the two connection parts (431) are separately connected to the two second connecting poles (442).

17. An oral care device at least comprising the base station unit (1000) according to claim 1 and an oral cleaner (2000), wherein
the base station unit (1000) is communicated with the oral cleaner (2000) by means of a conveying tube, and the base station unit (1000) can convey a liquid to the oral cleaner (2000) by means of the conveying tube, such that the liquid is sprayed out of a cleaning head of the oral cleaner (2000).

18. A vibration damping structure at least comprising a strut member (210), a first connector (220), and a first connecting arm (230), wherein
a first notch (211) is provided in a middle of the strut member (210), and the first notch (211) penetrates through the strut member (210); and
the first connector (220) is positioned within the first notch (211) and is connected to the strut member (210) by means of the first connecting arm (230), and the first connecting arm (230) has a bending section.

19. The vibration damping structure according to claim 18 further comprising a first covering member (240) having elastic properties, wherein
the first covering member (240) at least partially covers at least one of the strut member (210), the first connector (220), and the first connecting arm (230).
